(19) United States
(12) Patent Application Publication
(10) Pub. No.: US 2009/0295729 A1
(43) Pub. Date: Dec. 3, 2009

(54) INPUT DEVICE AND OPERATION METHOD OF COMPUTER SYSTEM

(75) Inventors: Chin-Chung Kuo, Taipei (TW); Ling-Chen Chang, Taipei (TW); Yih-Chieh Pan, Taipei (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: ASUSTek COMPUTER INC., Taipei (TW)

(21) Appl. No.: 12/424,542

(22) Filed: Apr. 16, 2009

(30) Foreign Application Priority Data
Jun. 3, 2008 (TW) 97120641

(51) Int. Cl. G09G 5/08

(52) U.S. Cl. 345/166

(57) ABSTRACT

An input device for a computer is provided. The input device includes a motion detector and a receiver. The motion detector has an inertia sensor, a gyro, an optical mouse module, and a microprocessor. When the motion detector is in a motion operation mode, the inertia sensor and the gyro are enabled for detecting a motion state and direction of the motion detector in a 3-D space, so as to generate an inertia data and a direction data. When the motion detector is in a mouse operation mode, the optical mouse module is enabled for detecting a motion stat of the motion detector on a 2-D plane, so as to generate a coordinate data. The microprocessor codes the coordinate data or codes the inertia data and the direction data to generate a detecting data for the receiver. Then, the detecting data is transmitted to the computer for operating the computer.

### CROSS-REFERENCE TO RELATED APPLICATION

This application claims the priority benefit of Taiwan application serial no. 97120641, filed on Jun. 3, 2008. The entirety of the above-mentioned patent application is hereby incorporated by reference herein and made a part of specification.

### BACKGROUND OF THE INVENTION

1. Field of the Invention

The present invention relates to an input device. More particularly, the present invention relates to an input device of a computer system and an operation method thereof.

2. Description of Related Art

An input device of a conventional computer system includes a keyboard, a mouse and a touch panel, etc. Keyboard input is performed by pressing keys on the keyboard by a user, and the mouse and the touch panel can be operated by the user on a 2-D plane, so as to operate the computer system.

Under some special circumstances, for example, playing a computer game, the conventional input device cannot provide a convenience input approach. Therefore, a plurality of special input devices is developed, for example, a joystick. Though the special input device makes operation of the computer game more interesting, it still cannot provide an intuitive control.

Recently, some computer game providers develop a method for operating the computer game according to a motion mode of the user in a 3-D space, by which interesting and reality of the computer game can be greatly improved. However, the conventional technique is limited to fixed game hosts and game software, and cannot be generally applied to all of the games, so that universalness and convenience thereof are greatly reduced.

### SUMMARY OF THE INVENTION

Accordingly, the present invention is directed to an input device of a computer system and an operation method thereof, which can mitigate deficiencies of a conventional technique.

The present invention provides an input device for a computer system, and the input device includes a first motion detector and a receiver. The first motion detector includes a first inertia sensor, a first gyro, and an optical mouse module for detecting a state of the first motion detector to generate a first detecting data. When the first motion detector is in a motion operation mode, the first inertia sensor and the first gyro are used for detecting a motion state of the first motion detector in a 3-D space. When the first motion detector is in a mouse operation mode, the optical mouse module is used for detecting a motion state of the first motion detector on a 2-D plane. When the first motion detector generates the first detecting data, the receiver receives the first detecting data via a wireless transmission path, and transmits the first detecting data to the computer system via a transmission interface, so as to correspondingly operate the computer system.

The present invention further provides an operation method for a computer system, which has a motion operation mode and a mouse operation mode. In the motion operation mode, an inertia sensor and a gyro are used for detecting a motion state and direction of an operating part in a 3-D space, so as to generate an inertia data and a direction data. Moreover, in the mouse operation module, an optical mouse module is used for detecting a motion state of the operating part on a 2-D plane, so as to generate a coordinate data. Moreover, according to the operation method of the present invention, the coordinate data or code the inertia data and the direction data can be coded to generate a detecting data for operating the computer system.

A beneficial effect of the present invention is that the input device of the present invention includes the gyro, the inertia sensor and the optical mouse module, so that a user can operate the computer via a more intuitive approach, and the input device can be used as a mouse.

In order to make the aforementioned and other objects, features and advantages of the present invention comprehensible, a preferred embodiment accompanied with figures is described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic diagram illustrating an input device of a computer system according to a preferred embodiment of the present invention.

FIG. 2A is a top view of a first motion detector according to a preferred embodiment of the present invention.

FIG. 2B is a side view of a first motion detector according to a first embodiment of the present invention.

FIG. 3A is a top view of a second motion detector according to a preferred embodiment of the present invention.

FIG. 3B is a side view of a second motion detector according to a first embodiment of the present invention.

FIG. 4 is a circuit block diagram illustrating a motion detecting device according to a preferred embodiment of the present invention.

FIG. 5 is a flowchart illustrating steps for a motion detecting device operating a computer system under a motion operation mode according to a preferred embodiment of the present invention.

FIG. 6 is a structural schematic diagram of a mouse module.

FIG. 7A and FIG. 7B are top views of a main motion detecting device according to a third embodiment of the present invention.

FIG. 8 is an internal circuit diagram of a receiver according to a preferred embodiment of the present invention.

### DESCRIPTION OF EMBODIMENTS

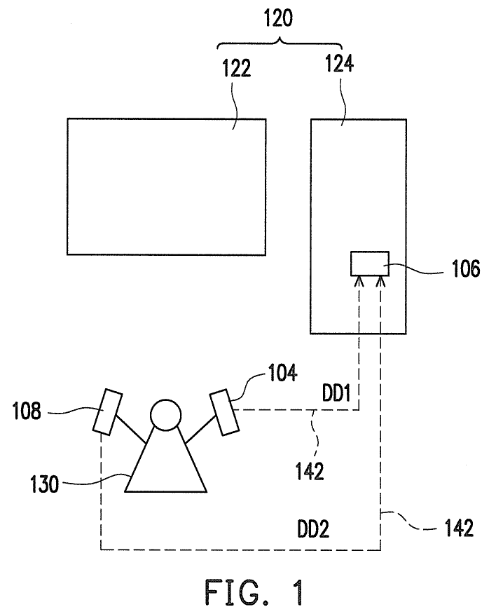

FIG. 1 is a schematic diagram illustrating an input device of a computer system according to a preferred embodiment of the present invention. Referring to FIG. 1, the input device includes a first motion detector 104 and a receiver 106. The first motion detector 104 is an operating part, which can detect actions of a user 130 for generating a detecting data DD1, and the detecting data DD1 can be transmitted to the receiver 106 via a wireless transmission path 142.

After the receiver 106 receives the detecting data DD1, it can be transmitted to a host device 124 of a computer system 120. In the present embodiment, the receiver 106 is a portable micro electronic device, which can be plugged into a port of the host device 124. Accordingly, the host device 124 is operated in response to the detecting data DD1, and displays a corresponding image for the user 130.

In the present embodiment, the wireless transmission path 142 is a bluetooth transmission path, while in some other embodiments, the wireless transmission path 142 can also be an infrared transmission path or a wireless network transmission path.

Besides the first motion detector 104, in some other embodiments, the input device provided by the present embodiment can further include a second motion detector 108. Similarly, the second motion detector 108 can also detect the actions of the user 130 and generate a detecting data DD2. Also, the receiver 106 can also receive the detecting data DD2 via the wireless transmission path 142 and transmit it to the host device 124.

In some embodiment, the second motion detector 108 first transmits the detecting data DD2 to the first motion detector 104, and then the first motion detector 104 transmits the detecting data DD2 to the receiver 106, wherein the second motion detector 108 is connected to the first motion detector 104 via a transmission line (not shown) for transmitting the detecting data DD2 to the first motion detector 104, or the second motion detector 108 is connected to the first motion detector 104 via a wireless approach for transmitting the detecting data DD2.

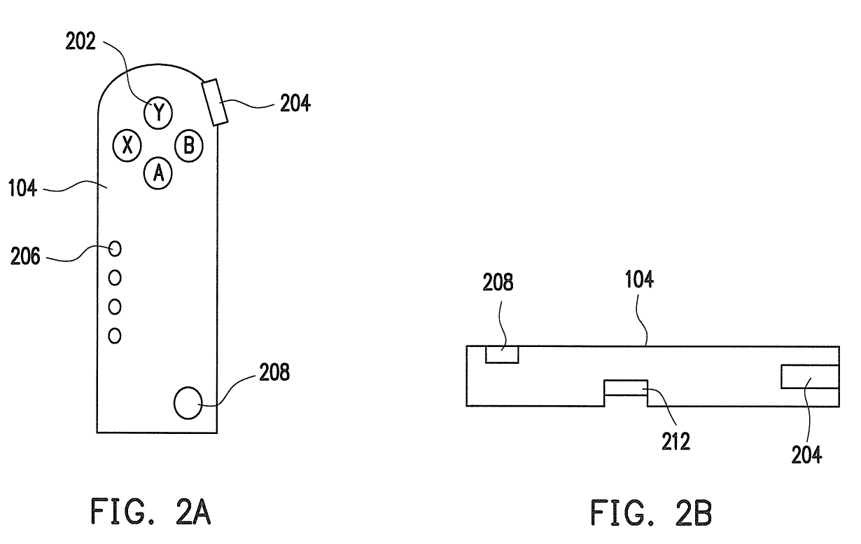

FIG. 2A is a top view of a first motion detector according to a preferred embodiment of the present invention. FIG. 2B is a side view of the first motion detector according to a first embodiment of the present invention. Referring to FIG. 2A and FIG. 2B, in the present embodiment, the first motion detector 104 includes a plurality of function keys 202, 204, 206 and 208. While a different function key is pressed, the first motion detector 104 can generate a corresponding action or a corresponding operation signal. For example, if the key 208 is pressed (enabled), it represents that power of the first motion detector 104 is activated. Moreover, the first motion detector 104 further includes an optical mouse module 212. Accordingly, the user can utilize the first motion detector 104 as an optical mouse.

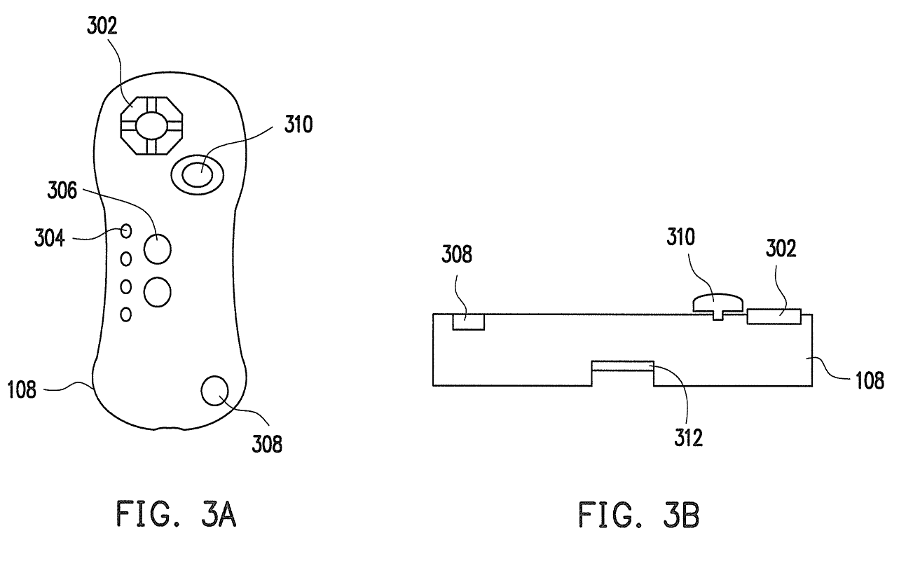

FIG. 3A is a top view of a second motion detector according to a preferred embodiment of the present invention. FIG. 3B is a side view of the second motion detector according to a first embodiment of the present invention. Referring to FIG. 3A and FIG. 3B, an optical mouse module 312 can also be selectively applied to the second motion detector 108 provided by the present embodiment. The second motion detector 108 can also include a plurality of the function keys 302, 304, 306 and 308. In the present embodiment, the key 302 is a 4-way navigation key, and the key 308 is a power key. Moreover, a joystick 310 can also be applied to the second motion detector 108.

Though appearances of the first motion detector and the second motion detector are disclosed in the above embodiment, the present invention is not limited thereto. For example, in some other embodiments, a touch panel (not shown) can also be applied to the first motion detector 104 and the second motion detector 108 for substituting the above function keys or the joystick.

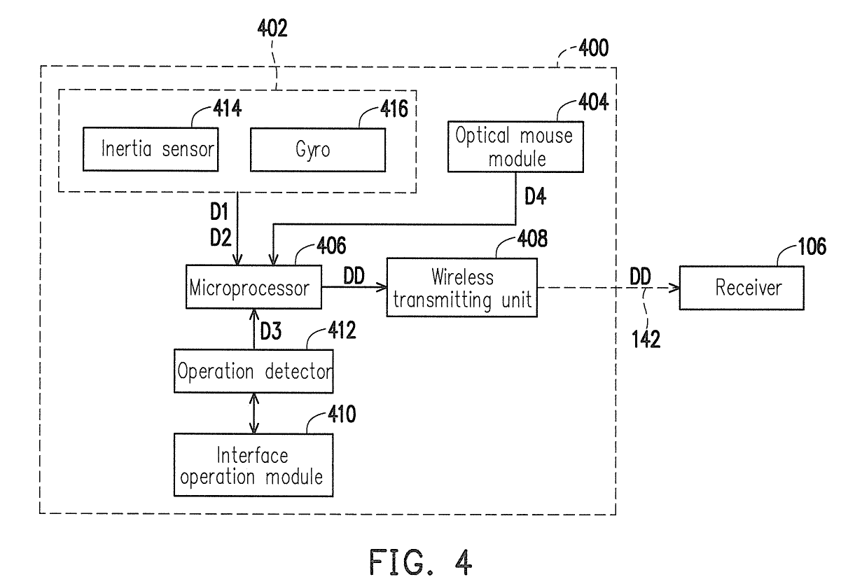

FIG. 4 is a circuit block diagram illustrating a motion detecting device according to a preferred embodiment of the present invention, which is suitable for the first motion detector 104 or the second motion detector 108 of FIG. 1. Referring to FIG. 4, the motion detecting device of the present embodiment includes a motion sensing module 402, an optical mouse module 404 and a microprocessor 406, wherein the motion sensing module 402 includes a an inertia sensor 414 and a gyro 416.

The microprocessor 406 is coupled to outputs of the motion sensing module 402 and the optical mouse module 404. In another embodiment, the main motion detecting device 400 further includes a wireless transmitting unit 408, an interface operation module 410 and an operation detector 412, wherein the interface operation module 410 can include the function keys, the joystick, the touch panel and other operation units.

Besides coupling to the microprocessor 406, the wireless transmitting unit 408 can also transmit/receive signals to/from the receiver 106 of FIG. 1 via the wireless transmission path 142. Moreover, an output of the interface operation module 410 is coupled to the operation detector 412, and an output of the operation detector is coupled to the microprocessor 408.

In the present embodiment, the motion detecting device 400 includes a motion operation mode and a mouse operation mode. When the motion detecting device 400 is switched to the motion operation mode, motion sensing module 402 can be enabled for detecting a motion state and direction of the motion detecting device 400 in a 3-D space. The inertia sensor 414 of the motion sensing module 402 is for detecting the motion state of the motion detecting device 400 in the 3-D space and outputting an inertia data D1, the gyro 416 of the motion sensing module 402 is for detecting the motion direction of the motion detecting device 400 in the 3-D space and generating a direction data D2.

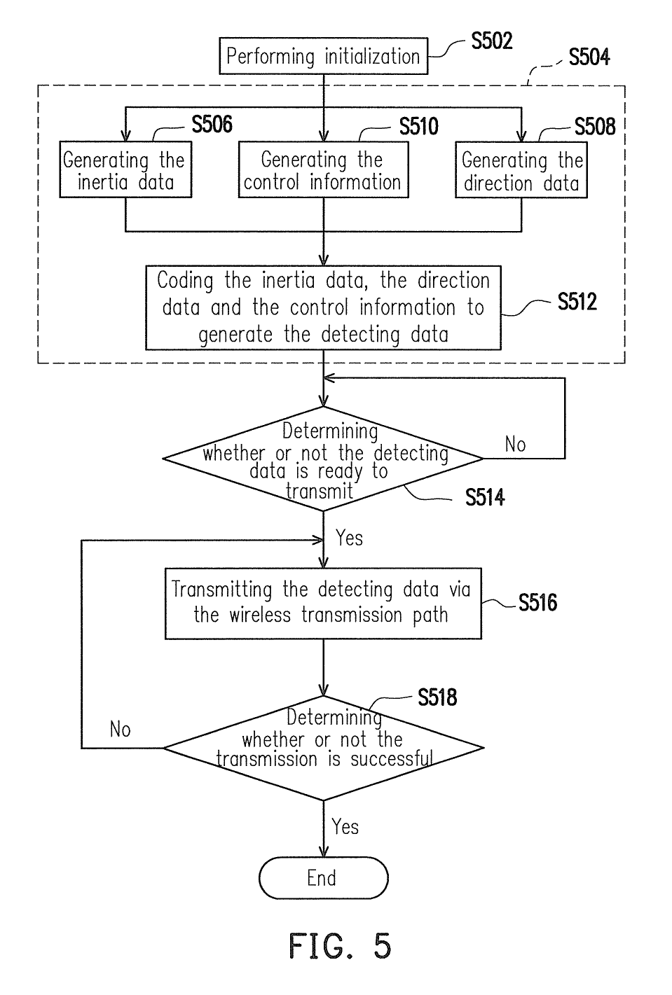

FIG. 5 is a flowchart illustrating steps for a motion detecting device operating a computer system under a motion operation mode according to a preferred embodiment of the present invention. Referring to FIG. 4 and FIG. 5, when the motion detecting device 400 is switched to the motion operation mode, in step S502, initialisation is performed, for example, the motion detecting device 400 is coupled to the receiver 106 via the wireless transmission path 142. Next, in step S504, the microprocessor 406 generates a detecting data DD according to an action of the motion detecting device 400.

In detail, when the motion detecting device 400 is moved in the 3-D space, in step S506, the inertia sensor 414 generates the inertia data D1 to the microprocessor 406, and in step S510, the gyro 416 generates the direction data D2 to the microprocessor 406. Moreover, in step S508, the operation detector 412 can detect an operation state of the user on the interface operation module 410 for generating a control information D3 to the microprocessor 406.

When the microprocessor 406 receives the inertia data D1, the direction data D2 and the control information D3, in step S512, the microprocessor 406 codes the inertia data D1, the direction data D2 and the control information D3 into the detecting data DD, and transmits the detecting data DD to the wireless transmitting unit 408. Next, in step S514, the wireless transmitting unit 408 judges whether transmission of the detecting data DD is ready. When the wireless transmitting unit 408 is ready to transmit the data via the wireless transmission path 142 (i.e. “yes” marked aside the step S514), in step S516, the wireless transmitting unit 408 transmits the detecting data DD to the receiver 106 via the wireless transmission path 142. Moreover, in the present embodiment, the wireless transmitting unit 408 further checks whether the detecting data DD is successfully transmitted as that described in step S518.

If the wireless transmitting unit 408 checks that the detecting data DD is not successfully transmitted (i.e. “no” marked aside the step S518), the step S516 is then repeated. Conversely, if the wireless transmitting unit 408 confirms that the detecting data DD is successfully transmitted (i.e. “yes” marked aside the step S518), the whole flowchart is then ended.

In the aforementioned embodiment, operations of the motion detecting device 400 under the motion operation mode are described. Comparatively, when the motion detecting device 400 is switched to the mouse operations mode, the optical mouse module 404 is enabled. Now, the optical mouse module 404 can detect a motion state of the motion detecting device 400 in the 2-D plane, and generate a coordinate data D4 to the microprocessor 406.

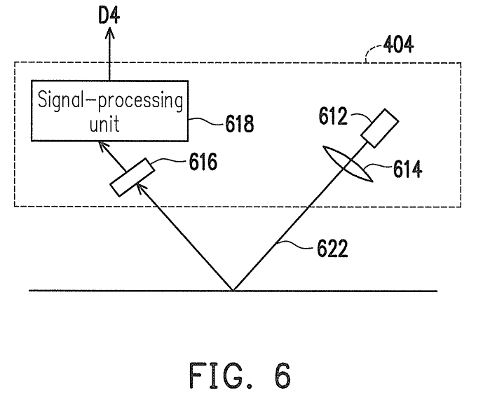

FIG. 6 is a structural schematic diagram of a mouse module. Referring to FIG. 6, the mouse module 404 includes a light-emitting source 612, an optical lens 614, a light-sensing unit 616 and a signal-processing unit 618. In the present embodiment, the light-emitting source 612 is a laser diode or a light-emitting diode, which can output a light beam 622 having a predetermined wavelength. The optical lens 614 is disposed on a transmission path of the light beam 622 to focus the light beam 622. When the light beam 622 reaches a plane, it can be reflected back to the mouse module 404. Now, the light-sensing unit 616 receives the reflected light beam 622 and sends a sensing result to the signal-processing unit 618. By such means, the signal-processing unit 618 can generate the coordinate data D4 according to an output of the light-sensing unit 616.

Referring to FIG. 4 again, when the motion detecting device 400 is switched to the mouse operation mode, a procedure of generating the detecting data is approximately the same to that in the motion operation mode (the flowchart disclosed in FIG. 5). A difference is that in the mouse operation mode, the optical mouse module 404 generates the coordinate data D4 to the microprocessor 406 for substituting the steps 506 and 510 of FIG. 5. By such means, the microprocessor 406 can codes the coordinate data D4 and the control information D3 into the detecting data DD. However, how the microprocessor 406 judges to code the direction data D3 or the coordinate data D4 into the detecting data DD is an important subject.

As described above, in some embodiments, the microprocessor 406 can judge whether the motion detecting device 400 is moved in a 3-D space or on a 2-D plane according to the inertia data D1. For example, when the user operates the motion detecting device 400 in the 3-D space, the inertia sensor 414 can detect acceleration variations on all direction axes in the 3-D space. However, when the user only operates the motion detecting device 400 on the 2-D plane, the inertia sensor 414 can detect acceleration variations on only two direction axes in the 3-D space, and the acceleration variation on the remained direction axis is almost maintained unchanged.

According to above description, the microprocessor 406 of the present embodiment judges a motion state of the motion detecting device 400 according to the inertia data D2. When the microprocessor 406 judges that the motion detecting device 400 is moved in the 3-D space, the microprocessor 406 disables the optical mouse module 404 for coding the direction data D2 into the detecting data DD.

Comparatively, when the microprocessor 406 judges that the motion detecting device 400 is only moved on the 2-D plane, the microprocessor 406 enables the optical mouse module 404 for coding the coordinate data D4 into the detecting data DD.

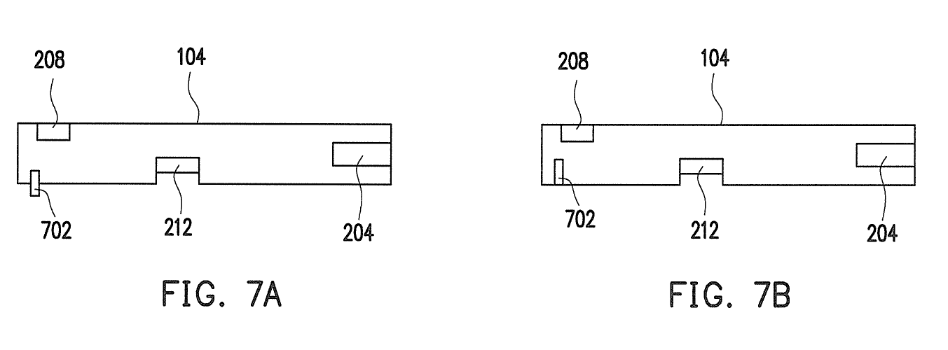

FIG. 7A and FIG. 7B are top views of a main motion detecting device according to another embodiment of the present invention. Referring to FIG. 7A and FIG. 7B, in the present embodiment, the first motion detector 104 is taken as an example. However, those skilled in the art can deduce that the second motion detector 108 can also be taken as the example. In the present embodiment, the first motion detector 104 includes a switch 702 coupled to the operation detector 412 of FIG. 4. When the switch 702 is in a state as that shown in FIG. 7A, the microprocessor 406 of FIG. 4 disables the optical mouse module 404 for coding the direction data D2 into the detecting data DD.

Comparatively, when the user takes the first motion detector 104 as the optical mouse and disposes it on a plane, the switch 702 is then enabled as that shown in FIG. 7B. Now, the operation detector 412 can send the corresponding control information D3 to the microprocessor 406. Accordingly, the microprocessor 406 can enable the optical mouse module 404 according to the control information D3, so as to receive the coordinate data D4 and code it into the detecting data DD.

Though in the embodiment of FIG. 7A and FIG. 7B, a position of the switch is illustrated, in an actual application, the switch 702 can be disposed at any position on the motion detector, so that the user can manually switch a working mode of the motion detector. In some other selective embodiments, the switch can also be implemented by a touch panel (not shown).

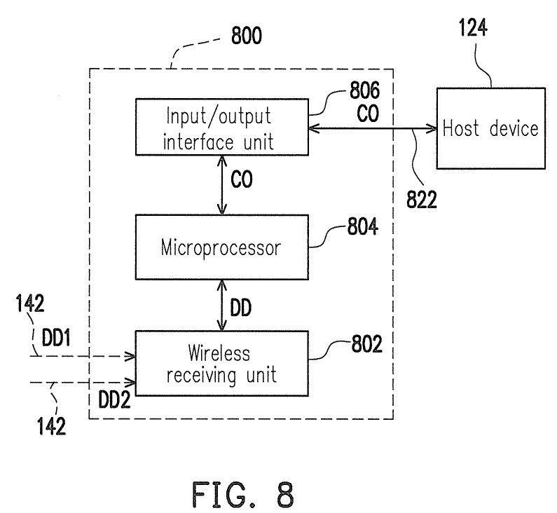

FIG. 8 is a block diagram illustrating a receiver according to a preferred embodiment of the present invention, which can be applied to the receiver 106 of FIG. 1. Referring to FIG. 8, the receiver 800 includes a wireless receiving unit 802, a microprocessor 804 and an input/output interface unit 806.

The microprocessor 804 is coupled to the wireless receiving unit 802 and the input/output interface unit 806. The wireless receiving unit 802 receives the detecting data DD via the wireless transmission path 142, and the input/output interface unit 806 is coupled to for example the host device 124 of FIG. 1 via the transmission interface 822.

In the present embodiment, the transmission interface 822 is a USB interface, and in other embodiment, the transmission interface 822 can also be an IEEE 1394 interface, a serial interface, a parallel interface or a PCMCIA. Comparatively, the input/output interface unit 806 can be implemented by different interfaces according to the transmission interface 822.

When the receiver 800 is connected to the host device 124 and is enabled, the receiver 106 can also be initialised, for example, establishing a wireless transmission path 322 with the motion detector 104 and the motion detector 106 of FIG. 1 or performing verification. After the receiver 106 is initialised, the wireless receiving unit 802 receives the detecting data DD transmitted from the first motion detector 104 via the wireless transmission path 142. Now, the wireless receiving unit 802 transmits the detecting data DD1 or DD2 to the microprocessor 804 for decoding the detecting data DD1 or DD2. When the first motion detector 104 or the second motion detector 106 is operated under the motion operation mode, after the detecting data DD1 or DD2 is decoded, the original inertia data D1, the direction data D2 and the control information D3 are generated (as shown in FIG. 4).

Next, the microprocessor 804 can further decode the inertia data D1 to obtain a motion information. The motion information includes for example, acceleration values of the motion detecting device on different coordinate axes in the 3-D space that are detected by the inertia sensor 414. Then, the microprocessor 804 generates a motion command according to the motion information.

In detail, after the microprocessor 804 obtains the motion information, whether such motion information can be identified is judged. If the microprocessor 804 can identify the motion information, a corresponding motion state is selected, for example, a straight line or an arc line motion action. Conversely, if the microprocessor 804 cannot identify such motion information, a similar motion state is selected according to calculated motion states. Accordingly, the microprocessor 804 generates a motion command according to the selected motion state.

Besides decoding the inertia data D1, the microprocessor 804 can further decode the direction data D2 to obtain a direction information, while such step is performed in case that the first motion detector 104 or the second motion detector 108 of FIG. 1 is operated in the motion operation mode. Comparatively, if the first motion detector 104 or the second motion detector 108 is operated in the mouse operation mode, the microprocessor 804 only needs to process the coordinate data D4 (as shown in FIG. 4) to obtain the related planar coordinate information.

Moreover, the microprocessor 804 can further identify a state of the control information D3 generated when the user operates the interface operation module 410 of FIG. 4. Accordingly, the microprocessor 804 can code the control information D3, the aforementioned planar coordinate information D4, or the motion command and a virtual coordinate information for generating an operation command CO to the input/output interface unit 806. When the input/output interface unit 806 receives the operation command CO, the operation command can be transmitted to the host device 124 via the transmission interface 822, so that the computer system 120 of FIG. 1 can be operated in response to the operation command CO.

In summary, the input device of the present invention includes the inertia sensor, the gyro, and the mouse module, so that a user can operate the computer in the 3-D space via a more intuitive approach, and the input device can be used as the optical mouse.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. An input device of a computer system, comprising:
a first motion detector, comprising a first inertia sensor, a first gyro, and an optical mouse module for detecting a state of the first motion detector to generate a first detecting data, wherein
when the first motion detector is in a motion operation mode, the first inertia sensor and the first gyro are used for detecting a motion state of the first motion detector in a 3-D space,
when the first motion detector is in a mouse operation mode, the optical mouse module is used for detecting a motion state of the first motion detector on a 2-D plane to generate a coordinate data; and
a receiver, plugged in a transmission interface of the computer system, for receiving the first detecting data or the coordinate data via a wireless transmission path, so as to correspondingly operate the computer system.

2. The input device of a computer system as claimed in claim 1, wherein the first motion detector further comprises:
a plurality of first keys;
an operation detector, for detecting a state of each first key to output a corresponding key control signal;
a first microprocessor, coupled to the operation detector, the first inertial detector, the first gyro and the optical mouse module, for coding the key control signal and the coordinate data output from the optical mouse module, or coding data output from the first inertia sensor and the first gyro to generate the first detecting data; and
a first wireless transmitting unit, coupled to the first microprocessor for transmitting the first detecting data or the coordinate data to the receiver via the wireless transmission path.

3. The input device of a computer system as claimed in claim 2, wherein the first microprocessor disables the optical mouse module when judging the first motion detector is moved in the 3-D space according to output data of the first inertia sensor, so as to coding the key control signal and the data output from the first inertia sensor and the first gyro into the first detecting data.

4. The input device of a computer system as claimed in claim 2, wherein the first microprocessor enables the optical mouse module when judging the first motion detector is moved on the 2-D plane according to the output data of the first inertia sensor, so as to coding the key control signal and data output from the optical mouse module into the first detecting data.

5. The input device of a computer system as claimed in claim 2 further comprising a switch coupled to operation detector, so that a user can manually switch a working mode of the first motion detector.

6. The input device of a computer system as claimed in claim 1, wherein the first motion detector further comprises a touch panel for performing touch operations.

7. The input device of a computer system as claimed in claim 1, wherein the receiver comprises:
a wireless receiving unit, for receiving the first detecting data via the wireless transmission path;
a second microprocessor, coupled to the wireless receiving unit, for decoding the first detecting data and generating a corresponding computer operation data; and
an input/output interface unit, coupled to the computer system via the transmission interface and coupled to the second microprocessor, for transmitting the computer operation data to the computer system via the transmission interface.

8. The input device of a computer system as claimed in claim 1 further comprising a second motion detector comprising a second inertia sensor for detecting a motion state of the second motion detector in the 3-D space, and outputting a second detecting data.

9. The input device of a computer system as claimed in claim 8, wherein the second motion detector comprises:
a plurality of second keys;
a joystick;
a second key detector, for detecting a state of each second key to output a corresponding second key control signal;
a joystick detector, for detecting a state of the joystick to output a joystick control signal;
a second microprocessor, coupled to the second key detector, the joystick detector and the second inertial detector for coding the second key control signal, the joystick control signal and an output data of the second inertia detector, so as to generate the second detecting data; and
a second wireless transmitting unit, coupled to the second microprocessor for transmitting the second detecting data to the receiver via the wireless transmission path.

10. The input device of a computer system as claimed in claim 9, wherein the second motion detector further includes a second gyro for sensing a motion direction of the second motion detector in the 3-D space.

11. The input device of a computer system as claimed in claim 8, wherein the second motion detector further includes a touch panel for performing touch operations.

12. A method for operating a computer system, comprising:
switching a motion operation mode or a mouse operation mode;
applying an inertia sensor and a gyro to detect a motion state and direction of an operating part in a 3-D space, and generate an inertia data and a direction data, when the motion operation mode is switched;
applying an optical mouse module to detect a motion state of the operating part on a 2-D plane, and generate a coordinate data, when the mouse operation mode is switched; and
coding the coordinate data or coding the inertia data and the direction data to generate a detecting data for operating the computer system.

13. The method for operating a computer system as claimed in claim 12 further comprising:
transmitting the detecting data from the operating part to a receiver via a wireless transmission part; and
transmitting the detecting data from the receiver to the computer system via a transmission interface.
